(19) United States
(12) Patent Application Publication
(10) Pub. No.: US 2002/0108261 A1
(43) Pub. Date: Aug. 15, 2002

(54) Self-aligning plumb apparatus

(76) Inventor: Stephen Miller, Arcadia, CA (US)

Correspondence Address: Jeffrey G. Sheldon, Esq., Sheldon & Mak, 9th Floor, 225 S. Lake Ave., Pasadena, CA, 91101, US

(21) Appl. No.: 09/783,270

(22) Filed: Feb. 13, 2001

(51) Int. Cl. G01C 15/10

(52) U.S. Cl. 33/283; 33/286; 33/392

(57) ABSTRACT

A self-aligning plumb apparatus has an elongated housing with a laser beam module in the housing. The end of the housing is pointed and is magnetized for suspending the apparatus from metallic beams and the like. The switch is mounted on the housing in a position where it is activated by a slidable plumb bob weight.

### BACKGROUND

The present invention relates generally to plumb bobs, and more particularly to a laser beam type plumb bob.

In building construction, many times it becomes necessary to locate a spot or align onto the ground, or onto an overhead structure. Conventionally, a gravity plumb bob is used, and two men are required, one person placing the upper end of the string of the plumb bob against an overhead surface while the other insures that the lower pointed end of the plumb bob itself is fully positioned by gravity.

A number of devices have been developed to improve upon the conventional plumb bob. Some of these devices use a laser light system. Exemplary of the prior art are the following U.S. Pat: 3,635,565; 3,667,849; 4,674,188; 5,012,585; 5,157,843; 5,481,809; 5,537,205; 5,704,131; 5,933,974; 5,894,675; 5,950,318; 6,005,719; 6,028,665; and 6,101,728.

These prior art devices suffer from one or more disadvantages, including high expense, complexity in use, sufficient ruggedness to be used in the hostile environment of a construction site, and inaccuracy. Accordingly, there is a need for a plumb apparatus that has none of the disadvantages of prior art structures.

### SUMMARY

The present invention is directed to an alignment apparatus, namely, a plumb apparatus, and a method of its use, that satisfy this need. Such an apparatus according to the present invention comprises an elongated housing having a longitudinal axis, an upper end, and a lower end. There is a laser beam module in the housing. The laser beam module is capable of producing a laser beam emitted from the lower end of the housing, the emitted beam is in alignment with the longitudinal axis of the housing. Power source means such as batteries in the housing are operably connected to the laser beam module. A switch is provided for activating the battery power source. The upper end of the housing is magnetic so the apparatus can be suspended from a metallic structure so that the emitted laser beam is substantially perpendicular to level ground.

Preferably the upper end of the housing is pointed, such as being a metallic bullet tip element. A permanent magnet can be proximate to the upper end of the housing for magnetizing it.

The apparatus can include a plumb bob weight slidably mounted on the exterior of the housing. The switch can be mounted on the housing and located so that when the lower end of the housing is pointed downwardly, the plumb bob weight slides downwardly and turns on the switch. This provides a hands-free operation for activating the laser beam module.

In use, the apparatus is suspended from a metallic structure such as a beam with the lower end of the housing facing downward. The switch is then turned on and the laser light is emitted. In some instances, if no structural beam is in an appropriate location, or there is no metallic beam available. A metallic extension bar can be attached to one of the beams and the apparatus can be suspended from the metallic extension bar.

### DRAWINGS

These and other features, aspects and advantages of the present invention will become better understood from the following description, appended claims, and accompanying drawings where:

FIG. 1 is a perspective view of an apparatus according to the present invention, in an off position;

FIG. 2 is a perspective view of the apparatus of FIG. 1 in an on position;

FIG. 3 is a sectional view of the apparatus of FIG. 1 taken on line 3-3 of FIG. 1; and

FIG. 4 is a view like that of FIG. 3 with the apparatus in its on position.

### DESCRIPTION

An apparatus 10 according to the present invention comprises an elongated housing 12 having a longitudinal axis 13, a lower end 14, a lower portion 15, a pointed upper end 16, and a hollow central bore 17. The housing 12 is made of three structural elements, a lower, generally tubular main portion 18 having an upper male extension 20, an upper portion 22 which is also generally tubular and slides over the extension 20, and a bullet tip portion 24. The bullet tip portion 24 has a cylindrical body 26 and a pointed end 28 which projects out of the upper end of the upper portion 22 of the housing 12 and forms the pointed upper end 16 of the housing 12 .

In the present invention the pointed end 16 of the housing, namely, the bullet tip, is magnetic. This can be effected by making the tip out of a magnetic, either a permanent magnet or an electromagnet. Alternatively, in a preferred version of the invention, the tip portion 24 is made of a magnetizable material, preferably iron and is magnetized by a permanent magnet 32. The permanent magnet 32 is cylindrical in shape and fits within an electrically conductive sleeve 33 in the upper portion 22 of the housing against the cylindrical body 26 of the bullet tip portion 24.

A suitable permanent magnet is one having sufficient power to support a 5 pound weight. This type of permanent magnet is of the type that is conventionally used in commercially available magnetic pick-up tools, thus minimizing the cost associated with the apparatus 10.

Preferably, the remainder of the housing, namely, the main portion 18 and upper portion 22 are made of a non-magnetizable material such as brass or copper, so that most of the housing does not attract filings and other pieces of metal, which are present at construction sites.

At the lower end 14 of the housing, within the central bore 17, there is mounted a laser beam module 36 having a lens 38 through which laser light is emitted. The laser beam module 36 is positioned so that the laser beam is emitted from the housing out through an opening 39 at the lower end 14 of the housing 12 in a direction substantially aligned with the longitudinal axis 13 of the housing.

An advantage of the present invention is that this module is the type found in commercially available laser pointers. Thus, because it is mass-produced, it is inexpensive.

The laser beam module 36 is powered by a pair of replaceable batteries 40 which are situated in series within the central bore 17 of the housing 12. Optionally, rechargeable batteries can be used, which can be recharged outside of the housing, or the apparatus can be modified so the batteries can be charged while still in the housing. In a much less preferred version of the invention, an external power source can be used.

A switch 42 is mounted on the lower portion 15 of the housing 10 for turning the laser beam module on and off.

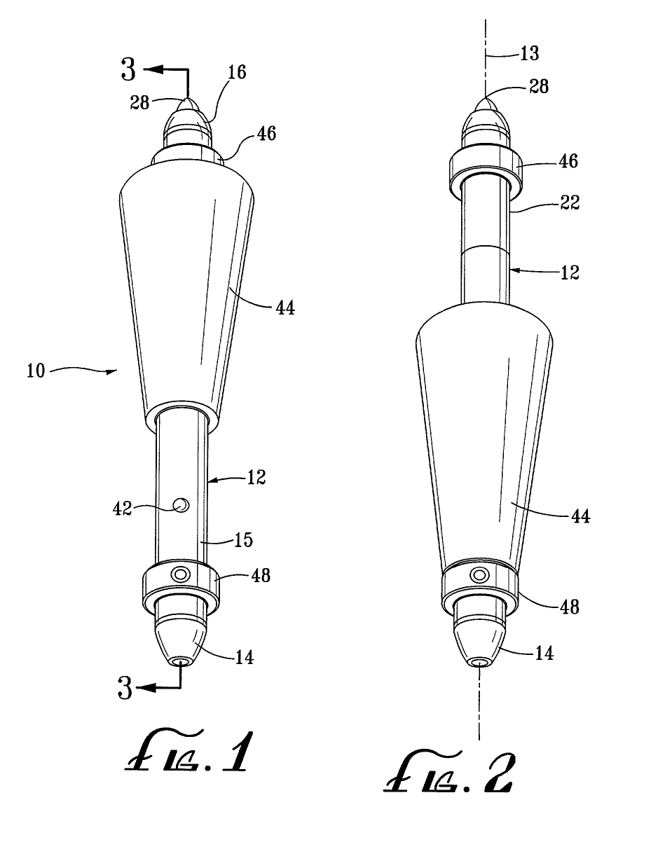

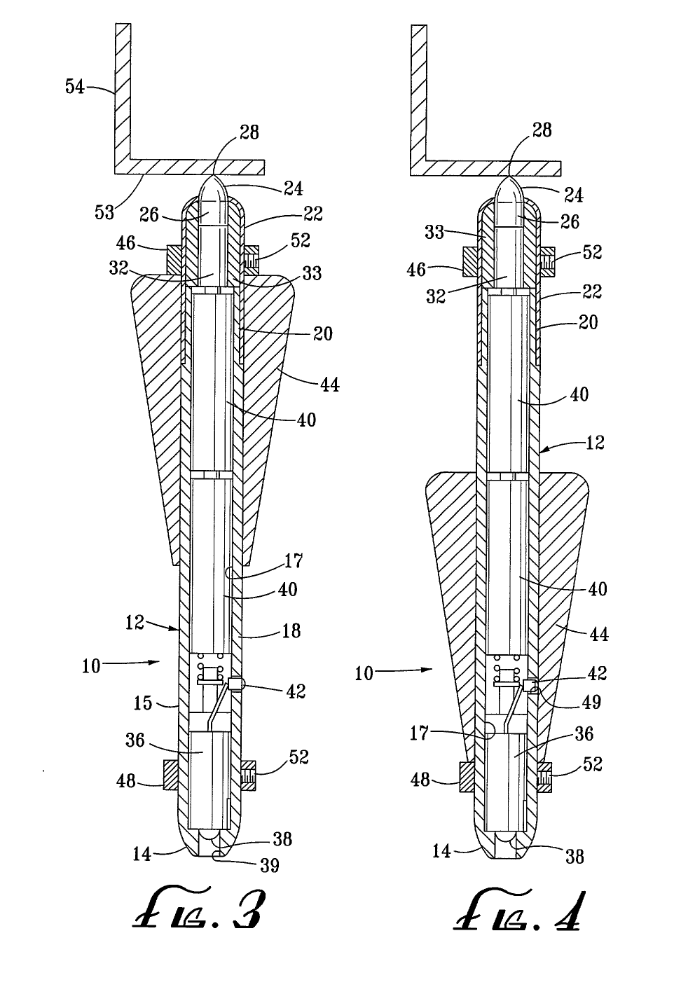

For improved accuracy, preferably the apparatus includes a plumb bob weight 44, typically formed of a heavy metal such as brass, which is mounted on the exterior of the housing 12. Preferably the weight 44 is slidably mounted on the exterior housing to slide by the force of gravity from an upper to a lower position as shown in FIGS. 1 and 2. The longitudinal movement of the plumb bob weight 44 is limited by an upper stop collar 46 and a lower stop collar 48. The collars are held in place by respective set screws 52. Optionally, a flat portion can be included on the exterior of the housing to seat the set screw, or there can be an indentation in the housing, or an opening into the housing, to receive the set screw.

In a preferred version of the invention, the switch 42 is activated by the plumb bob weight 44. The switch 42 projects out of the housing through a small opening 49. As the plumb bob weight slides downwardly from the position shown in FIG. 1 to the position in FIG. 2, the switch is forced inwardly into the housing, thereby powering the batteries and turning on the laser beam module.

The apparatus 10 is of simple and durable construction, of parts that are commercially available at low prices, or easily machinable. Moreover, the apparatus 10 is easy to use. As shown in FIGS. 1 and 2, all that is necessary to use in the apparatus is to place the bullet tip 28 against the bottom 53 of a metallic structural element such as a beam or angle iron 54. Due to the weight of the apparatus 10, including the weight provided by the plumb bob weight 44, the apparatus 10 hangs substantially vertically, even in mildly windy conditions with its longitudinal axis 13 vertical. Thus, laser light emitted by the laser beam module 36 is substantially perpendicular to level ground. In the preferred version of the invention, it is not even necessary for the person using the device to activate the switch 44 off, that occurring automatically by the plumb bob weight 44 sliding downwardly to the position shown in FIGS. 2 and 4.

In the event that a metallic element for suspending the apparatus 10 is not available, all that is necessary to do is to secure a scrap piece of metal or other metallic element to the structure at a suitable location, and utilize that for suspending the apparatus 10.

An advantage of the present invention is that it is not necessary that there by a horizontal surface to use it. Because it is self-aligning it can be used for construction projects where there are no level elements.

It is apparent that the apparatus is of simple and economical construction, and very easy to use in that it can be used by a single person, not requiring two workmen. For example, a workman can suspend it from a desired location, and then proceed to mark the line or spot identified by the laser beam.

Although the present invention has been described in considerable detail with reference to certain preferred versions thereof, other versions are possible. For example, instead of the set screw, other types of fasteners can be used. Optionally, a stop element can be built into the housing, where the exterior of the housing has fabricated therein a stop element. Also, stop elements can be permanently attached to the exterior of the housing, such as by an adhesive or welding. Further, the bullet tip portion 24 need not extend as far as shown in the Figures. A lesser amount of extension, approximately only 1/32 inch, prevents use of the apparatus on highly sloped structures. It has been determined that if the bullet tip extends more than about ¼ inch, and if the apparatus 10 is used by suspending it from a surface sloped more than 45°, inaccurate readings can result.

Therefore, the scope of the appended claims should not be limited to the description of the preferred versions contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Also, any element in a claim that does not explicitly state “means for” performing a specified function or “step for” performing a specified function, should not be interpreted as a “means” or “step” clause as specified in 35 U.S.C. §112.

What is claimed is:

1. A self-aligning alignment apparatus comprising:
(a) an elongated housing have a longitudinal axis, an upper end, and a lower end;
(b) a laser beam module in the housing and capable of producing a laser beam emitted from the lower end of the housing in alignment with the longitudinal axis of the housing;
(c) power source means operably connected to the laser beam module; and
(d) a switch for activating the power source,
wherein the upper end of the housing is magnetic so that the apparatus can be suspended from a metallic structure so that an emitted laser beam is substantially perpendicular to level ground.

2. The apparatus of claim 1 comprising a plumb bob weight mounted on the exterior of the housing.

3. The apparatus of claim 2 wherein the plumb bob weight is slidably mounted on the exterior of the housing.

4. The apparatus of claim 1 wherein the upper end of the housing is pointed.

5. The apparatus of claim 4 comprising a metallic bullet tip element forming the pointed upper end of the housing.

6. The apparatus of claim 5 comprising a permanent magnet proximate to the upper end of the housing for magnetizing the upper end of the housing.

7. The apparatus of claim 6 wherein the permanent magnet is in the housing.

8. The apparatus of claim 1 wherein the upper end of the housing is a permanent magnet.

9. A self-aligning plumb apparatus comprising:
(a) an elongated housing have a longitudinal axis, a pointed upper end, and a lower end, wherein the pointed upper end of the housing is formed of a magnetizable material;
(b) a laser beam module in the housing and capable of producing a laser beam emitted from the lower end of the housing in alignment with the longitudinal axis of the housing;
(c) a battery power source mounted in the housing and operably connected to the laser beam module;
(d) a switch mounted on the housing for activating the battery power source; and
(e) a permanent magnet in the housing for magnetizing the pointed upper end of the housing so that the apparatus can be suspended from a metallic structure so that an emitted laser beam is substantially perpendicular to level ground.

10. The apparatus of claim 9 wherein the pointed end of the housing is formed of a metallic bullet tip element.

11. The apparatus of claim 9 wherein the switch is mounted to project to the exterior of the housing.

12. The apparatus of claim 11 comprising a plumb bob weight slidably mounted on the exterior of the housing so that when the lower end of the housing is pointed downwardly the plumb bob weight slides downwardly and turns on the switch.

13. The apparatus of claim 10 wherein the portion of the housing proximate to the permanent magnet, other than the pointed end of the housing, is made of a non-magnetizable material.

14. A self-aligning plumb apparatus comprising:
(a) an elongated housing have a longitudinal axis, a pointed upper end, and a lower end, wherein the pointed upper end of the housing is formed of a magnetizable material;
(b) a laser beam module in the housing and capable of producing a laser beam emitted from the lower end of the housing in alignment with the longitudinal axis of the housing;
(c) a battery power source mounted in the housing and operably connected to the laser beam module;
(d) a switch mounted on the exterior of the housing for activating the battery power source;
(e) a permanent magnet in the housing proximate to the upper end of the housing for magnetizing the pointed upper end of the housing so that the apparatus can be suspended from a metallic structure so that an emitted laser beam is substantially perpendicular to level ground; and
(f) a plumb bob weight slidably mounted on the exterior of the housing so that when the lower end of the housing is pointed downwardly the plumb slides downwardly and turns on the switch, and when the upper end of the housing is pointed downwardly, the plumb bob weight slides downwardly and turns off the switch.

15. The apparatus of claim 14 wherein the portion of the housing adjacent the permanent magnet, other than the pointed end of the housing, is made of a non-magnetizable material.

16. A method of forming a visible reference line comprising:
(a) selecting the apparatus of claim 1;
(b) suspending the selected apparatus from a metallic structure with the lower end of the housing facing downwardly; and
(c) turning on the switch.

17. The method of claim 16 wherein the reference line is to be formed in connection with the construction of a structure having structural elements, and the step of suspending comprises securing a metallic extension to one of the structural elements and suspending the apparatus from the metallic extension.

18. A method of forming a visible reference line comprising:
(a) selecting the apparatus of claim 9;
(b) suspending the selected apparatus from a metallic structure with the lower end of the housing facing downwardly; and
(c) turning on the switch.

19. The method of claim 18 wherein the reference line is to be formed in connection with the construction of a structure having structural elements, and the step of suspending comprises securing a metallic extension to one of the structural elements and suspending the apparatus from the metallic extension.

20. A method of forming a visible reference line comprising:
(a) selecting the apparatus of claim 14;
(b) suspending the selected apparatus from a metallic structure with the lower end of the housing facing downwardly, wherein the plumb bob weight slides downwardly and turns on the switch.

21. The method of claim 20 wherein the reference line is to be formed in connection with the construction of a structure having structural elements, and the step of suspending comprises securing a metallic extension to one of the structural elements and suspending the apparatus from the metallic extension.

22. The apparatus of claim 14 wherein the pointed end of the housing is formed of a metallic bullet tip element.
